(19) United States
(12) Patent Application Publication
(10) Pub. No.: US 2026/0229592 A1
(43) Pub. Date: Aug. 6, 2026

(54) GEL ELECTROLYTE

(71) Applicant: Sumitomo Chemical Co., Ltd, Tokyo (JP)

(72) Inventors: Florence Bourcet, Godmanchester (GB); Paulina Librizzi, Godmanchester (GB)

(73) Assignee: Sumitomo Chemical Co., Ltd, Tokyo (JP)

(21) Appl. No.: 19/151,064

(22) PCT Filed: Jan. 26, 2024
(86) PCT No.: PCT/EP2024/052005

§ 371 Date: Jul. 25, 2025

(30) Foreign Application Priority Data
Jan. 27, 2023 (GB) 2301240.4

(51) Int. Cl. H01M 10/0565; H01M 10/0525; H01M 10/058

(52) U.S. Cl. CPC H01M 10/0565; H01M 10/0525; H01M 10/058; H01M 2300/0082; H01M 2300/0085

(57) ABSTRACT

A gel electrolyte comprising a polymer, a get solvent and a compound of formula (I): wherein X is Al or B; R¹ in each occurrence is independently a substituent and two R groups may be linked to form a ring; and M⁺ is a cation. The gel electrolyte may be used in a metal battery or a metal ion battery.

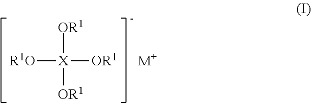

### BACKGROUND

WO 99/12938 discloses a polyfluorinated alkoxide coordinated to a transition metal, or a Group III, IV or V element. Use of the compound in batteries is disclosed.

Nolan et al, “Nonaqueous Lithium Battery Electrolytes Based on Bis(polyfluorodiolato)borates” 2003 J. Electrochem. Soc. 150 A1726 discloses lithium salts for use as battery electrolytes.

JP2002/260734 discloses electrolytes of formula (1):

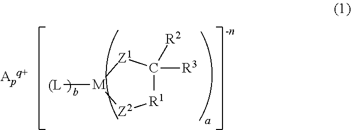

U.S. Pat. No. 6,783,896 discloses compounds of formula (I):

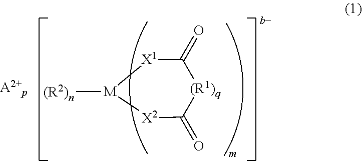

EP1075036 discloses compounds of formula (1):

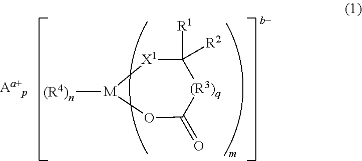

Takahiro Aoki et al, “Lithium ion conductivity of gel polymer electrolytes containing insoluble lithium tetrakis(pentafluorobenzenethiolato) borate” Journal of Power Sources Volume 156, Issue 2, 1 Jun. 2006, Pages 589-593 discloses lithium ion conducting gel polymer electrolytes composed of insoluble lithium tetrakis(pentafluorobenzenethiolato) borate (LiTPSB), poly(vinylidene fluoride-co-hexafluoropropylene) (PVDF-HFP) and ethylene carbonate-propylene carbonate mixed solvent (EC-PC).

WO2022/243470 discloses an electrolyte comprising solvated lithium ions.

### SUMMARY

The present disclosure provides a gel electrolyte comprising a polymer, a gel solvent and a compound of formula (I):

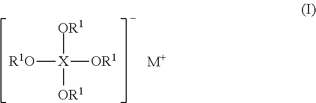

wherein X is Al or B; R¹ in each occurrence is independently a substituent and two R¹ groups may be linked to form a ring; and M⁺ is a cation.

Optionally, the compound of formula (I) has formula (Ia):

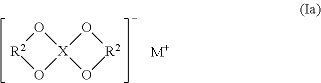

wherein R² in each occurrence is independently a divalent organic group.

Optionally, each R² is a group of formula (II):

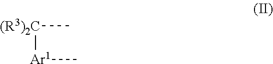

wherein R³ in each occurrence is H or a substituent and Ar¹ is a C₆₋₂₀ arylene group.

Optionally, Ar¹ is unsubstituted or substituted 1,2-phenylene.

Optionally, the mass of the polymer in the gel is no more than 30% of the mass of the compound of formula (I).

Optionally, M⁺ is a lithium ion.

Optionally, the polymer is a crosslinkable polymer.

Optionally, the polymer is a crosslinked polymer.

The present disclosure provides a battery comprising an anode, a cathode and a gel electrolyte as described herein disposed between the anode and the cathode.

Optionally, the metal battery contains no more than 16 moles of total solvent per mole of M+.

The present disclosure provides a method of forming a metal battery as described herein or a battery precursor thereof wherein formation of the gel electrolyte comprises deposition of a formulation comprising the polymer, the gel solvent, the compound of formula (I) and a deposition solvent onto a surface and evaporation of the deposition solvent.

Optionally, the polymer is crosslinkable, the method further comprising crosslinking the crosslinkable polymer.

Optionally, the surface is a surface of an electrode or an electrode current collector.

Optionally, following evaporation of the deposition solvent, the gel electrolyte is separated from the surface and applied to an electrode or an electrode current collector surface.

### DESCRIPTION OF DRAWINGS

FIG. 1 is a schematic illustration of a battery having a gel electrolyte as described herein;

FIG. 2 shows Nyquist plots for cells containing a gel electrolyte according to some embodiments of the present disclosure.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. References to a layer “over” another layer when used in this application means that the layers may be in direct contact or one or more intervening layers may be present. References to a layer “on” another layer when used in this application means that the layers are in direct contact. References to an element of the Periodic Table include any isotopes of that element.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

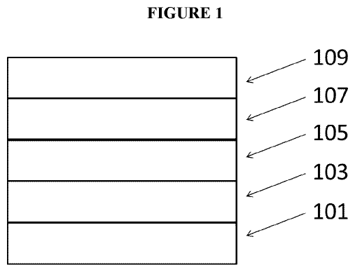

FIG. 1 illustrates a battery. The battery may be a metal battery or a metal ion battery, preferably a lithium battery or a lithium ion battery.

The battery comprises an anode current collector 101 in contact with an anode 103 on a surface thereof; a cathode current collector 109 in contact with a cathode 107; and a layer 105 comprising or consisting of a gel electrolyte as described herein disposed between the anode and cathode.

In some embodiments, layer 105 is a gel layer comprising a polymer; a solvent; and a compound of formula (I).

In some embodiments, layer 105 is a porous separator comprising a gel as described herein absorbed into the porous separator.

In the case of a metal ion battery, e.g., a lithium ion battery, the anode comprises an active material, e.g., graphite, for absorption of the metal ions.

In the case of a metal battery, the anode 103 is a layer of metal (e.g. lithium) which is formed over the anode current collector during charging of the battery and which is stripped during discharge of the battery.

The cathode may be selected from any cathode known to the skilled person.

The anode and cathode current collectors may be any suitable conductive material known to the skilled person, e.g. one or more layers of metal or metal alloy such as aluminium or copper.

For simplicity, FIG. 1 illustrates a battery in which the anode and cathode are separated only by a layer comprising or consisting of a gel, however it will be understood that in use a solid-electrolyte interphase will typically form on the anode surface.

In other embodiments, one or more further layers may be disposed between the anode and the gel and/or the cathode and the gel.

### Compounds of Formula (I)

Formula (I) is:

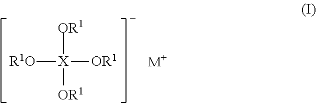

X is Al or B.

R¹ in each occurrence is independently a substituent and two R¹ groups may be linked to form a ring.

M⁺ is a cation. M⁺ is preferably an alkali metal cation, more preferably lithium.

In some embodiments, two pairs of R¹ groups are linked and the compound of formula (I) has formula (Ia):

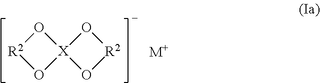

wherein R² in each occurrence is independently a divalent organic group.

In the case where none of the R¹ groups are linked, preferably each R¹ independently in each occurrence is a C₁₋₂₀ alkyl group wherein one or more non-adjacent C atoms of the alkyl group may be replaced with O, S, CO or COO and one or more H atoms of the alkyl group may be replaced with F.

Preferred R¹ groups include C₁₋₂₀ alkyl wherein one or more C atoms other than the C atom bound to O of OR¹ or a terminal C atom may be replaced with O, and one or more H atoms may be replaced by F.

In the case of Formula (Ia), R² is preferably selected from: Ar¹ wherein Ar¹ in each occurrence is independent an optionally substituted C₆₋₂₀ arylene group, e.g. 1,2-phenylene, which may be unsubstituted or substituted with one or more substituents; a bi-arylene group of formula Ar¹-Ar¹, for example 2,2′-linked biphenylene which may be unsubstituted or substituted with one or more substituents; ethylene; propylene; and a group of formula (II):

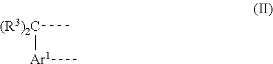

wherein R³ in each occurrence is H or a substituent and Ar¹ is a C₆₋₂₀ arylene group, preferably unsubstituted or substituted 1,2-phenylene.

Preferably, R³ in each occurrence is independently H or a C₁₋₆ alkyl group in which one or more H atoms may be replaced with F and one or more non-terminal C atoms may be replaced with O.

In a preferred embodiment, at least one R³, optionally each R³, is a C₁₋₆ perfluoroalkyl group.

Preferably, each Ar¹ of formula (I) is phenylene, more preferably a 1,2-linked phenylene which is unsubstituted or substituted with one or more substituents.

Where present, substituents of Ar¹ are preferably and independently selected from F and C₁₋₁₂ alkyl wherein one or more non-adjacent, non-terminal C atoms of the C₁₋₁₂ alkyl may be replaced with O, S, NR⁴, CO COO or CONR⁴ wherein R⁴ in each occurrence is independently a C₁₋₁₂ hydrocarbyl group, and one or more H atoms of the C₁₋₁₂ alkyl group may be replaced with F.

By “non-terminal C atom” of an alkyl chain as used herein is meant the methyl group at the chain end of a linear alkyl chain or each one of the methyl groups at the chain ends of a branched alkyl group.

A C₁₋₁₂ hydrocarbyl group as described anywhere herein is preferably selected from C₁₋₁₂ alkyl; phenyl; and phenyl substituted with one or more C₁₋₆ alkyl groups.

The compound of formula (I) may be formed by reacting a compound of formula (III) with either a compound of formula (IVa) or (IVb) in the case where R¹ groups are not linked, or a compound of formula (V) in the case of compounds of formula (Ia):

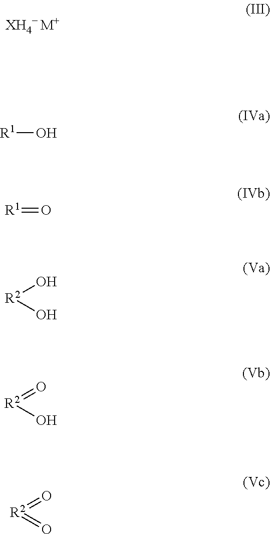

The compound of formula (IVa) may be a primary, secondary or tertiary alcohol.

The compound of formula (IVb) may be an aldehyde or a ketone.

Exemplary compounds of formula (III) include, without limitation, lithium aluminium hydride (LiAlH₄) and lithium borohydride (LiBH₄).

### Polymer

The polymer may be selected from any known ion-conducting polymers including, without limitation: poly(alkylene oxide), for example poly(ethylene oxide) and poly(propylene oxide); and fluorinated polymers such as polyvinylidene fluoride, PVDF-HFP; PMMA; polyacrylonitrile; polycarbonate; polyethylene; polypropylene; poly(vinyl methyl ketone); polyvinylpyrrolidone; polyether ether ketone; polyisoprene; polybutadiene; polystyrene-block-polyisoprene-block-polystyrene; poly(l-vinylpyrrolidone-co-vinyl acetate); polystyrene-block-polybutadiene-block-polystyrene; polystyrene-block-poly(ethylene oxide)-block-polystyrene; co-polymer and mixtures thereof.

The polymer is suitably a neutral polymer, i.e. not a polymer substituted with ionic groups, and in particular is suitably not a single-ion conducting polymer comprising anionic groups.

Preferably, the mass of the polymer in the gel is 3-90%, more preferably 5-30 wt %, of the mass of the compound of formula (I).

In some embodiments, the polymer of the gel is crosslinked. In some embodiments, the crosslinked gel polymer may be formed by reaction of an uncrosslinked polymer substituted with a substituent comprising a crosslinkable group. The crosslinkable group may be a group of formula (VI):

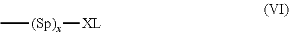

wherein Sp is a spacer group; x is 0 or 1; and XL is a crosslinkable group.

Optionally, XL is selected from
(i) an acyclic unit of formula —CR⁵═CH₂ wherein R⁵ is H or a substituent, preferably a C₁₋₆ alkyl group, for example vinyl, styryl acrylate or methacrylate;
(ii) a cyclic alkene, preferably an optionally substituted norbornene, cyclopropene or cyclobutene;
(iii) an optionally substituted epoxide; and
(iv) an optionally substituted benzocyclobutene.

The crosslinkable group comprising an optionally substituted benzocyclobutene may have formula (VI):

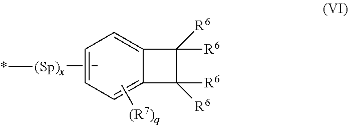

wherein R⁶ in each occurrence is H or a substituent; q is 0, 1, 2 or 3, preferably 0; and R⁷ in each occurrence is a substituent.

Preferably, of two R⁶ groups bound to the same carbon atom at least one R⁶ is H. Optionally, each R⁶ of formula (VI) is H or only one R⁶ of formula (IV) is not H. Exemplary non-H groups R⁶ are C₁₋₆ alkyl and C₁₋₆ alkoxy.

R⁷, if present, is preferably selected from F, Cl, NO₂, CN, C₁₋₆ alkyl and C₁₋₆ alkoxy.

Sp is preferably selected from optionally substituted phenylene; and C₁₋₂₀ alkylene wherein one or more H atoms of the C₁₋₂₀ alkylene may be replaced with F and one or more non-adjacent C atoms may be replaced with O, S, NR⁴, Si(R⁸)₂, CO, COO or CONR⁴ wherein R⁴ is H or a substituent as described above and each R⁸ is independently a substituent, optionally a C₁₋₂₀ hydrocarbyl group.

Optional substituents of a phenylene group Sp are F; CN; NO₂; and C₁₋₂₀ alkylene wherein one or more H atoms may be replaced with F and one or more non-adjacent C atoms may be replaced with O, S, NR⁴, Si(R⁸)₂, CO, COO or CONR⁴.

In some embodiments, the crosslinked gel polymer is formed by reaction of a composition comprising the compound of formula (I), the gel solvent and a monomer for forming a crosslinked polymer. The composition may contain only one monomer. The composition may contain two or more different monomers. The composition may comprise an initiator.

### Solvent

The gel comprises at least one solvent.

The one or more solvents may be selected from C₂₋₁₀ alkylene carbonates, di(C₁₋₁₀ alkyl) carbonates, for example propylene carbonate, ethylene carbonate, dimethyl carbonate; linear, branched or cyclic compounds containing two more ether groups, for example glyme, diglyme, triglyme and tetraglyme, 1,3-dioxolane, 2,5-dimethyl tetrahydrofuran; succinonitrile: cyclic lactones, for example γ-Butyrolactone and mixtures thereof.

Preferably, the one or more solvents have a boiling point of at least 200° C.

Preferably, the gel contains no more than 16 moles, optionally no more than 10 moles, of total solvent per mole of M+. The solvent/M+ ratio may be determined from integration of a 1H NMR spectrum of the completed gel prior to battery formation.

The presence of solvent has been found to significantly increase the ionic conductivity of the compound of formula (I). Without wishing to be bound by any theory, this increase is attributed to solvation of the M⁺ cation.

### Gel Formation

The gel may be formed by depositing a solution containing the compound of formula (I), the gel solvent, the gel polymer, or a crosslinkable gel polymer (which may be a crosslinkable monomer or crosslinkable polymer) and a deposition solvent onto a surface followed by evaporation of the deposition solvent and, in the case of a crosslinkable gel polymer, crosslinking of the crosslinkable gel polymer to form a crosslinked gel polymer.

Crosslinking of a crosslinkable polymer may be achieved by any method known to the skilled person, including thermal treatment or radiation, e.g. UV radiation. If crosslinking is performed after a cell has been assembled then thermal treatment is preferred given that the cell casing will typically be opaque.

The deposition solvent or solvents suitably have a lower boiling point than the gel solvent, preferably at least 100° C. lower than the gel solvent or solvents. Exemplary deposition solvents include, without limitation, tetrahydrofuran, dimethoxyethane, acetone, acetonitrile, dimethyl carbonate and mixtures thereof.

### Battery Formation

A battery may be formed by providing a gel as described herein on a surface of one of an anode and a cathode and providing the other of an anode and cathode, and associated current collector, over the gel.

A battery precursor may be formed by providing a gel as described herein on a surface of an anode current collector; and providing the cathode and a cathode current collector over the gel. Upon application of a charging bias, a lithium anode may be formed between the gel and the anode current collector.

In some embodiments, the gel may be formed by depositing a solution onto an electrode or a current collector followed by evaporation of the deposition solvent and, in the case of a crosslinkable polymer, crosslinking of the polymer.

In some embodiments, a preformed gel is deposited onto an electrode or current collector.

### EXAMPLES

### Electrolyte Preparation

All solutions were prepared in a nitrogen filled glovebox (02<0.1 ppm, H₂O<3 ppm).

A stock solution of PVDF-HFP (Mn=110 kDa, Mw=455) in tetrahydrofuran: propylene carbonate (THF:PC, 90:10, v:v), of 100 mg/ml concentration was prepared.

Solution 1 containing Compound Example 1 and PC was prepared with 1.93 molecule of PC per molecule of lithium cation.

Solution 2 containing Compound Example 2, PC and THF was prepared with 5.83 molecule of PC and 0.55 molecules of THF per molecule of lithium cation.

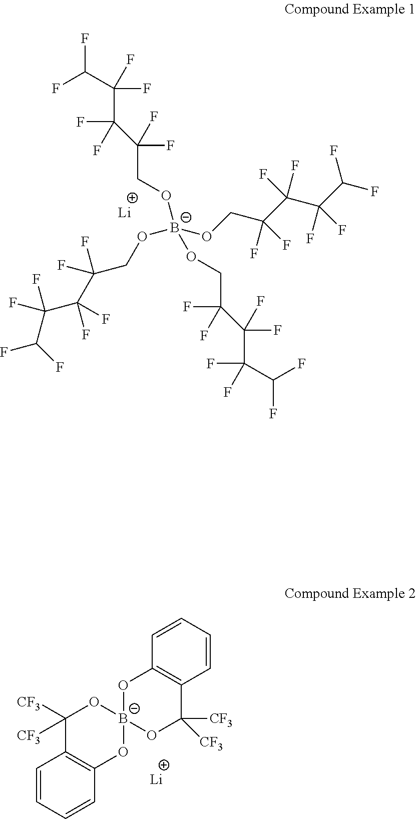 [SMILES: FC(F)C(F)(F)C(F)(F)C(F)(F)CO[B-](OCC(F)(F)C(F)(F)C(F)(F)C(F)F)(OCC(F)(F)C(F)(F)C(F)(F)C(F)F)OCC(F)(F)C(F)(F)C(F)(F)C(F)F ; [Li+] ; FC(F)(F)C1(C(F)(F)F)O[B-]2(Oc3ccccc31)Oc1ccccc1C(C(F)(F)F)(C(F)(F)F)O2 ; [Li+]]

### Gel Example 1

163 mg of Solution 1 was weighed out into a 2 ml clear glass vial. 0.15 ml of PVDF-HFP stock solution was added to it. Upon homogenisation the mixture gelled out. An extra 0.15 ml THF:PC (9:1) solution was added to it to yield a clear free flowing solution.

### Gel Example 2

73 mg of Solution 1 was weighed out into a 2 ml clear glass vial. 0.2 ml of PVDF-HFP stock solution was added to it. After mixing a clear free flowing solution was obtained.

### Gel Example 3

30 mg of Solution 1 was weighed out into a 2 ml clear glass vial. 0.25 ml of PVDF-HFP stock solution was added to it. After mixing a clear free flowing solution was obtained.

### Gel Example 4

11 mg of Solution 1 was weighed out into a 2 ml clear glass vial. 0.25 ml of PVDF-HFP stock solution was added to it. After mixing a clear free flowing solution was obtained.

### Gel Example 5

3.5 mg of Solution 1 was weighed out into a 2 ml clear glass vial. 0.25 ml of PVDF-HFP stock solution was added to it. After mixing a clear free flowing solution was obtained.

### Gel Example 6

230 mg of Solution 1 was weighed out into a 2 ml clear glass vial. 0.10 ml of PVDF-HFP stock solution was added to it. Upon homogenisation the mixture gelled out. An extra 0.12 ml of THF:PC (9:1) solution was added to it to yield a clear free flowing solution.

### Gel Example 7

343 mg of Solution 1 was weighed out into a 2 ml clear glass vial. 0.5 ml of PVDF-HFP stock solution was added to it. Upon homogenisation the mixture gelled out. An extra 0.20 ml of THF:PC (9:1) solution was added to it to yield a clear free flowing solution.

### Gel Example 8

0.220 ml of Gel Example 7 solution was placed into a 2 ml clear glass vial. 0.033 ml of PC were added to it. After mixing a clear free flowing solution was obtained.

### Gel Example 9

0.220 ml of Gel Example 7 solution was placed into a 2 ml clear glass vial. 0.066 ml of 1,2-dimethoxyethane (1,2-DME) were added to it. After mixing a clear free flowing solution was obtained.

### Gel Example 10

0.180 ml of Gel Example 7 solution was placed into a 2 ml clear glass vial. 0.0405 ml of PC and 0.054 ml of 1,2-DME were added to it. After mixing a clear free flowing solution was obtained.

### Gel Example 11

295 mg of Solution 2 was weighed out into a 2 ml clear glass vial. 0.15 ml of PVDF-HFP stock solution was added to it. Upon homogenisation the mixture gelled out. An extra 0.10 ml of THF:PC (9:1) solution was added to it to yield a clear free flowing solution.

### Gel Example 12

620 mg of Solution 2 was weighed out into a 2 ml clear glass vial. 0.5 ml of PVDF-HFP stock solution was added to it. After mixing a clear free flowing solution was obtained

### Gel Example 13

0.220 ml of Gel Example 12 solution was placed into a 2 ml clear glass vial. 0.033 ml of PC was added to it. After mixing a clear free flowing solution was obtained.

### Gel Example 14

11.7 mg of PEG400 was placed into a 2 ml clear glass vial. 0.220 ml of Gel Example 12 solution was added to it. After mixing a clear free flowing solution was obtained.

### Gel Example 15

0.200 ml of Gel Example 12 solution was placed into a 2 ml clear glass vial. 0.030 ml of PC and 0.060 ml of 1,2-DME were added to it. After mixing a clear free flowing solution was obtained.

### Cell Formation—Gel Electrolyte

0.2 ml of each of Gel Examples 1-15 were drop-cast using a micropipette onto a stainless steel disk on a hotplate set at 30° C.

After 15 minutes, the temperature was increased to 40° C. and films were dried for 1 hour. The hotplate was then turned off and disks were left to cool down to room temperature.

All solutions gave film with gel like consistencies, from very soft gels to gels that can be removed from the stainless steel disk and remain intact.

Films supported on the stainless steel disks were then transferred under inert atmosphere to an Argon filled glovebox for cell assembly.

Films supported on the stainless steel disks were cut to an 8 mm disk diameter using a manual cutter. The outer part was peeled off the surface of the stainless-steel disk and kept for NMR analysis to determine solvent content. Any remaining material was removed using a swab impregnated with THF.

A silicone spacer of 200 microns thickness shaped as a disk of diameter 16 mm with a circular hole of diameter 9 mm cut in its middle was placed on the stainless steel disk so as to surround the 8 mm diameter film.

To form a coin cell, the stainless steel disk carrying the gel film and the silicone spacer was placed on a further stainless steel disk in a coin cell bottom. On top of the spacer a second stainless-steel disk was placed, plus a wave spring and the coin cell top, followed by crimping.

The silicone spacer ensures that the gel film thickness following crimping is 200 microns, thereby allowing for accurate conductivity calculations and preventing squeezing of the gel film to a low thickness following crimping which may cause shorting.

### Cell Formation-Solution Electrolyte

For the purpose of comparison, coin cells containing electrolyte solutions having varying concentrations of Compound Example 1 or 2 without any polymer were prepared. The cells were fabricated by inserting a stainless steel spacer in a coin cell bottom, followed by a fluoro-silicone spacer. The stencil is shaped as a disk of diameter 155 mm, with a circular hole of diameter 5 mm cut in its middle. 30 μl of electrolyte solution was filled into the spacer opening.

On top of the stencil two stainless steel spacers were placed, plus a wave spring and the coin cell top, followed by crimping. The thickness of the stencil in the crimped cell is 360 μm.

All coin cells were assembled in a rigorously dry and oxygen-free Argon gas-filled MBraun glovebox.

### Electrochemical Impedance Spectroscopy

EIS measurements of coin cells were conducted at room temperature using a potentiostat (Interface 1010E, Gamry Instruments).

The EIS spectrums were taken over a frequency range of 1 Hz to 1 MHz, with an amplitude of 5 mV.

Ionic conductivities were calculated using the following formula:

$$σ = \frac{l}{A \cdot R}$$

where:
1-thickness of the material between the two stainless disks, which corresponds to the thickness of the separator,
A-area of the hole in the separator,
R-impedance.

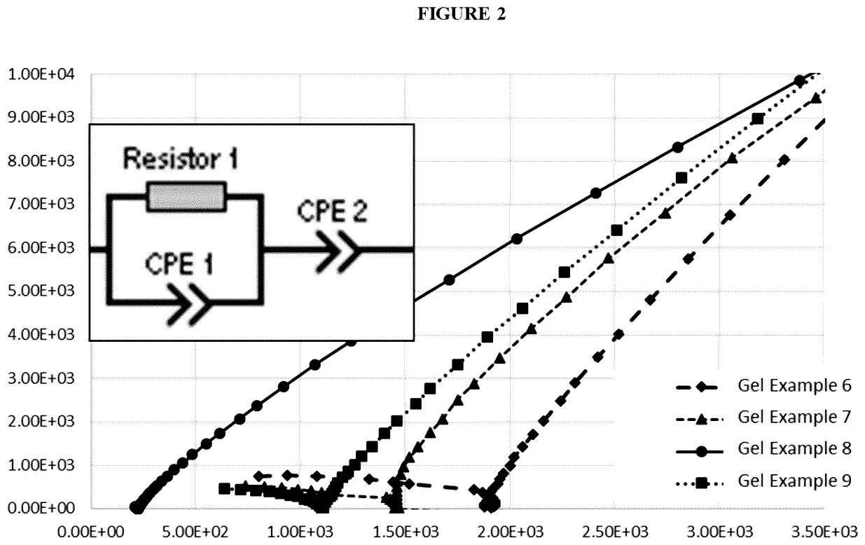

The impedance of the cell was determined by fitting an equivalent circuit to the Nyquist plot (FIG. 2 inset)—Resistor 1 corresponds to the x-intercept of the 1^{st} semi-circle on the x-axis of the Nyquist plot (FIG. 2).

Resistor 1 was used to calculate the conductivity of the material in accordance with the formula given above. Ionic conductivities are set out in Table 1.

TABLE 1

| | | Ionic | | Polymer/ionic |
|---|---|---|---|---|
| | Ionic | conductivity | Mol of PC/ | molecule |
| Material | Compound | (S/cm) | mol of Li+ | (w/w %) |
| Gel | Compound | 6.1 × 10⁻⁵ | 4.3 | 10% |
| Example 1 | Example 1 | | | |
| Gel | Compound | 1.9 × 10⁻⁵ | 3.4 | 25% |
| Example 2 | Example 1 | | | |
| Gel | Compound | 2.2 × 10⁻⁵ | 3.3 | 5% |
| Example 6 | Example 1 | | | |
| Gel | Compound | 2.5 × 10⁻⁵ | 4.3 | 15% |
| Example 7 | Example 1 | | | |
| Gel | Compound | 1.6 × 10⁻⁴ | 8.9 | 15% |
| Example 8 | Example 1 | | | |
| Gel | Compound | 3.3 × 10⁻⁵ | 4.0 | 15% |
| Example 9 | Example 1 | | | |
| Gel | Compound | 1.6 × 10⁻⁴ | 8.9 | 15% |
| Example 10 | Example 1 | | | |
| Gel | Compound | 6.6 × 10⁻⁴ | 6.4 | 10% |
| Example 11 | Example 2 | | | |
| Gel | Compound | 4.8 × 10⁻⁴ | 6.1 | 15% |
| Example 12 | Example 2 | | | |
| Gel | Compound | 6.7 × 10⁻⁴ | 9.2 | 15% |
| Example 13 | Example 2 | | | |
| Gel | Compound | 3.4 × 10⁻⁴ | 6.0 | 26.1% |
| Example 14 | Example 2 | | | |
| Solution 1 | Compound | 2.8 × 10⁻⁵ | 3.5 | 0% |
| | Example 1 | | | |
| Solution 1 | Compound | 4.6 × 10⁻⁵ | 4.3 | 0% |
| | Example 1 | | | |
| Solution 2 | Compound | 2.4 × 10⁻⁴ | 6.2 | 0% |
| | Example 1 | | | |
| Solution 2 | Compound | 5.0 × 10⁻⁴ | 8.1 | 0% |
| | Example 1 | | | |

Compound Example 2 provides higher ionic conductivities than Compound Example 1.

Ionic conductivities and gel softness increase with increasing solvent additive content.

Increasing the amount of polymer results in lower ionic conductivity, and makes the gels less adhesive to metal and glass surfaces, but also more robust.

1. A gel electrolyte comprising a polymer, a gel solvent and a compound of formula (I): 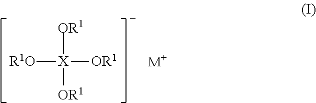
wherein X is Al or B; R¹ in each occurrence is independently a substituent and two R¹ groups may be linked to form a ring; and M⁺ is a cation.

2. The gel electrolyte according to claim 1 wherein the compound of formula (I) has formula (Ia): 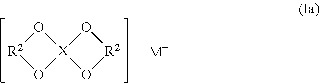
wherein R² in each occurrence is independently a divalent organic group.

3. The gel electrolyte according to claim 2 wherein each R² is a group of formula (II): 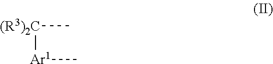
wherein R³ in each occurrence is H or a substituent and Ar¹ is a C₆₋₂₀ arylene group.

4. The gel electrolyte according to claim 3 wherein Ar¹ is unsubstituted or substituted 1,2-phenylene.

5. The gel electrolyte according to claim 1 wherein the mass of the polymer in the gel is no more than 30% of the mass of the compound of formula (I).

6. The gel electrolyte according to claim 1 wherein M⁺ is a lithium ion.

7. The gel electrolyte according to claim 1 wherein the polymer is a crosslinkable polymer.

8. The gel electrolyte according to claim 1 wherein the polymer is a crosslinked polymer.

9. A battery comprising an anode, a cathode and a gel electrolyte according to claim 1 disposed between the anode and the cathode.

10. The battery according to claim 9 wherein the metal battery contains no more than 16 moles of total solvent per mole of M+.

11. A method of forming a battery comprising an anode, a cathode and a gel electrolyte according to claim 1 disposed between the anode and the cathode or a battery precursor thereof wherein formation of the gel electrolyte comprises deposition of a formulation comprising the polymer, the gel solvent, the compound of formula (I) and a deposition solvent onto a surface and evaporation of the deposition solvent.

12. The method according to claim 11 wherein the polymer is crosslinkable, the method further comprising crosslinking the crosslinkable polymer.

13. The method according to claim 11 wherein the surface is a surface of an electrode or an electrode current collector.

14. The method according to claim 11 wherein, following evaporation of the deposition solvent, the gel electrolyte is separated from the surface and applied to an electrode or an electrode current collector surface.
